(19) United States
(12) Patent Application Publication
(10) Pub. No.: US 2016/0180353 A1
(43) Pub. Date: Jun. 23, 2016

(54) ANALYZING DATA OF CROSS BORDER TRANSACTIONS WITHIN A NETWORK TRADING PLATFORM

(71) Applicant: Steven Chien, Menlo Park, CA (US)

(72) Inventor: Steven Chien, Menlo Park, CA (US)

(21) Appl. No.: 14/580,123

(22) Filed: Dec. 22, 2014

(51) Int. Cl. G06Q 30/02; G06Q 10/08

(52) U.S. Cl. CPC G06Q 30/0201; G06Q 10/0831

(57) ABSTRACT

Disclosed are a system comprising a computer-readable storage medium storing at least one program, and a computer-implemented method for generating cross-border evaluation data for evaluating cross-border transactions within an online marketplace. A database interface module accesses aggregated sales data that is indicative of sales values linked to respective origin countries and respective destination countries. A transaction monitor module determines whether a transaction event satisfies a user notification rule linked to a user account that is indicative of an origin country. An analysis module generates, based at least on a selected portion of the aggregated sales data, cross-border evaluation data in response to a determination that the transaction event satisfies the user notification rule.

### TECHNICAL FIELD

Example embodiments of the present application relate generally to the technical field of data processing.

### BACKGROUND

Network-based marketplaces can be used for the buying and selling of goods and services. Technology to aid sellers with their transaction processes include manual offline accounting (e.g., spreadsheets, databases, etc.), and disparate buyer-based reporting systems (e.g., online transaction history summaries for a particular buyer). Manual offline accounting systems may involve the sellers inputting data twice, and devoting time and resources to updating databases and spreadsheets offline from individual network-based trading systems. Similarly, disparate buyer-based reporting systems can provide to sellers limited transaction details for a buyer, and different systems (e.g., different network-based trading systems) are used to administer reporting systems on different networks.

### BRIEF DESCRIPTION OF THE DRAWINGS

In the drawings, which are not necessarily drawn to scale, like numerals can describe similar components in different views. Like numerals having different letter or numeric suffixes can represent different instances of similar components. The drawings illustrate generally, by way of example, but not by way of limitation, various embodiments discussed in the present document.

FIG. 1 is a network diagram depicting a client-server system, within which one example embodiment can be deployed.

FIG. 2 is a block diagram illustrating a mobile device, according to an example embodiment.

FIGS. 3A and 3B are interface diagrams illustrating example user interfaces of a web resource with multiple display elements delivered to a user device by a data analysis system, according to an example embodiment.

FIG. 4 is a block diagram illustrating an example embodiment of a data analysis system including multiple modules forming at least a portion of the client-server system of FIG. 1.

FIG. 5 is a block diagram illustrating an example data structure of a data analysis system, in accordance with an example embodiment.

FIG. 6 is a flowchart illustrating an example method of providing cross-border evaluation data based on aggregated sales data of an online marketplace, in accordance with an example embodiment.

FIG. 7 is a flowchart illustrating an example method of generating the cross-border evaluation data of FIG. 6, in accordance with an example embodiment.

FIG. 8 is a flowchart illustrating another example method of generating the cross-border evaluation data of FIG. 6, in accordance with an example embodiment.

FIG. 9 is a block diagram of a machine in the example form of a computer system within which instructions can be executed for causing the machine to perform any one or more of the methodologies discussed herein.

### DETAILED DESCRIPTION

Reference will now be made in detail to specific example embodiments for carrying out the inventive subject matter. Examples of these specific embodiments are illustrated in the accompanying drawings. It will be understood that they are not intended to limit the scope of the claims to the described embodiments. On the contrary, they are intended to cover alternatives, modifications, and equivalents as can be included within the spirit and scope of the disclosure as defined by the appended claims. In the following description, specific details are set forth in order to provide a thorough understanding of the subject matter. Embodiments can be practiced without some or all of these specific details. In addition, well known features may not have been described in detail to avoid unnecessarily obscuring the subject matter.

In accordance with the present disclosure, components, process steps, and/or data structures are implemented using various types of operating systems, programming languages, computing platforms, computer programs, and/or like machines. In addition, those of ordinary skill in the art will recognize that devices, such as hardwired devices, field programmable gate arrays (FPGAs), application specific integrated circuits (ASICs), or the like, can also be used to exploit one or more technical aspects of the devices without departing from the scope and spirit of the concepts disclosed herein. Embodiments can also be tangibly embodied as a set of computer instructions stored on a computer readable medium, such as a memory device, to exploit technical aspects of a computer-instruction based embodiments.

Example methods and systems for alerting a seller user (e.g., a merchant) about a cross-border transaction, providing information and insights about the type of transaction, and providing related recommendations, which are embodied on electronic devices, are described. In the following description, for purposes of explanation, numerous specific details are set forth in order to provide a thorough understanding of example embodiments. It will be evident, however, to one skilled in the art, that the present inventive subject matter can be practiced without these specific details.

In an example embodiment, data related to cross-border transactions within an online market place can be provided to users automatically based on detecting certain transaction events. For example, a data analysis system monitors transaction events within an online marketplace. The transaction events can correspond to cross-border sales transactions (e.g., the sale of an item from a seller from one country to a buyer from another country). A cross-border transaction can be determined based on the location (e.g., origin country) listed in the corresponding user accounts, not necessarily the location of the users at the time of the sale. The data analysis system can aggregate transaction event data over time for later processing and analysis. In response to a determination that a transaction event satisfies a notification rule linked to a seller user, the data analysis system processes the aggregated transaction event data and generates cross-border evaluation data to be provided to the seller user automatically. The cross-border evaluation data can serve to determine new cross-border selling opportunities within the online marketplace. For instance, the cross-border evaluation data can include data related to a number of total sales values of cross-border sales transactions grouped by country corridors. In this way, the seller user can discover selling opportunities from the seller user's origin country to new or more profitable destination countries. Additionally or alternatively, the cross-border evaluation data can include data of cross-border transactions within a particular country corridor grouped by vertical markets. In this way, the seller user can discover selling opportunities to new or more profitable vertical markets.

For example, in response to the seller user receiving a first payment in a particular foreign currency, the data analysis system can automatically provide cross-border evaluation data to the seller user upon the next log-in. The cross-border evaluation data can include a message to congratulate the seller user on the first foreign payment of this type received, provide a list of reference users in the seller user's category who sell to the same region based on the currency and statistics about those sales, recommend other countries to market the product based on the currency, suggest solutions for cross-border trade (e.g., shipping, insurance, custom, etc.), and/or provide a trend of the exchange rate between the new currency and seller user's currency.

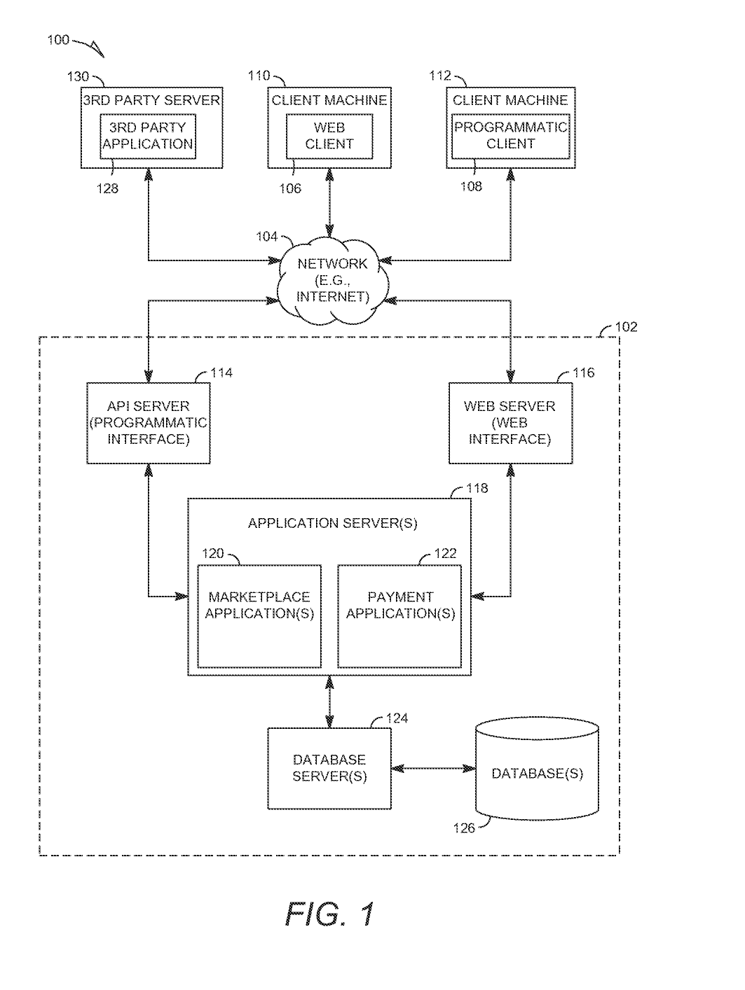

FIG. 1 is a network diagram depicting a client-server system 100, within which one example embodiment can be deployed. A networked system 102, in the example form of a network-based marketplace or publication system, provides server-side functionality, via a network 104 (e.g., the Internet or wide area network (WAN)), to one or more clients. FIG. 1 illustrates, for example, a web client 106 (e.g., a browser), and a programmatic client 108 executing on respective client machines 110 and 112. Herein, the client machine 110 can be referred to as a “client device” or “user device” in various applications.

An application program interface (API) server 114 and a web server 116 are coupled to, and provide programmatic and web interfaces respectively to, one or more application servers 118. The application servers 118 host one or more marketplace applications 120, and payment applications 122. The application servers 118 are, in turn, shown to be coupled to one or more database servers 124 that facilitate access to one or more databases 126.

The marketplace application(s) 120 can provide a number of marketplace functions and services to users that access the networked system 102. The payment application(s) 122 can likewise provide a number of payment services and functions to users. The payment application(s) 122 can allow users to accumulate value (e.g., in a commercial currency, such as the U.S. dollar, or a proprietary currency, such as “points”) in accounts, and then later to redeem the accumulated value for items that are made available via the marketplace application(s) 120.

Further, while the system 100 shown in FIG. 1 employs a client-server architecture, the present inventive subject matter is, of course, not limited to such an architecture, and could equally well find application in a distributed, or peer-to-peer, architecture system, for example. The various marketplace and payment applications 120, 122 could also be implemented as standalone software programs, which do not necessarily have networking capabilities.

In addition, while the various marketplace and payment applications 120, 122 have been described above as having separate functionalities, in alternative embodiments these functionalities can be performed by any one or more of the various marketplace and payment applications 120, 122.

The web client 106 accesses the various marketplace and payment applications 120 and 122 via the web interface supported by the web server 116. Similarly, the programmatic client 108 accesses the various services and functions provided by the marketplace and payment applications 120 and 122 via the programmatic interface provided by the API server 114. The programmatic client 108 can, for example, be a seller application (e.g., the TURBOLISTER™ application developed by EBAY INC.™, of San Jose, Calif.) to enable sellers to author and manage listings on the networked system 102 in an off-line manner, and to perform batch-mode communications between the programmatic client 108 and the networked system 102.

FIG. 1 also illustrates a third party application 128, executing on a third party server 130, as having programmatic access to the networked system 102 via the programmatic interface provided by the API server 114. For example, the third party application 128 can, utilizing information retrieved from the networked system 102, support one or more features or functions on a website hosted by the third party. The third party website can, for example, provide one or more promotional, marketplace, or payment functions that are supported by the relevant applications of the networked system 102.

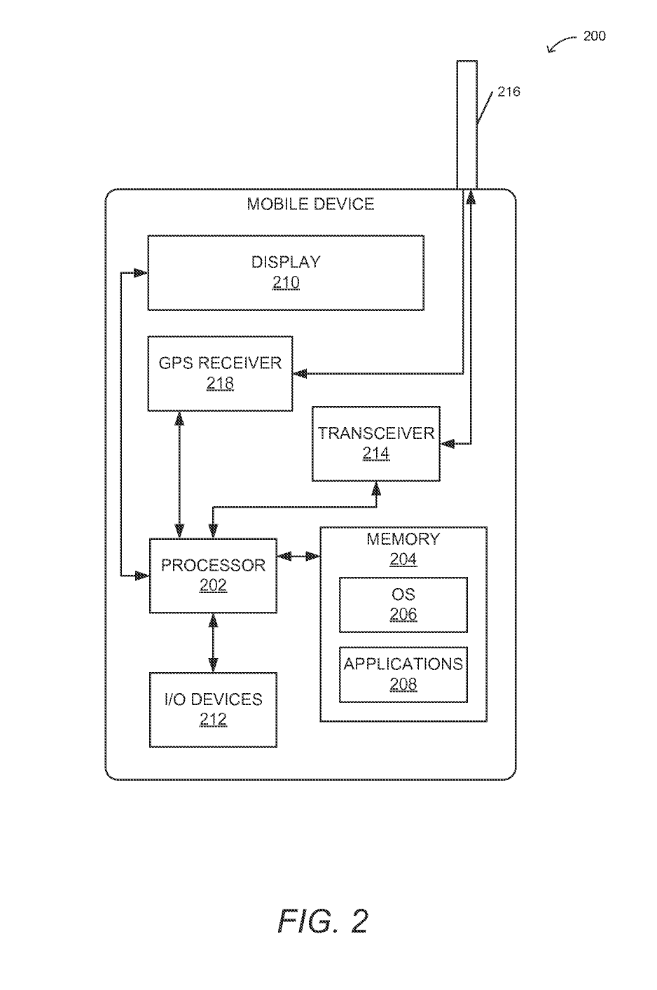

FIG. 2 is a block diagram illustrating a mobile device 200, according to an example embodiment. The mobile device 200 can include a processor 202. The processor 202 can be any of a variety of different types of commercially available processors specially configured for mobile devices 200 (for example, an XScale architecture microprocessor, a microprocessor without interlocked pipeline stages (MIPS) architecture processor, or another type of processor). A memory 204, such as a random access memory (RAM), a Flash memory, or other type of memory, is typically accessible to the processor 202. The memory 204 can be adapted to store an operating system 206, as well as application programs 208, such as a mobile location-enabled application that can provide location based services (LBSs) to a user. The processor 202 can be coupled, either directly or via appropriate intermediary hardware, to a display 210 and to one or more input/output (I/O) devices 212, such as a keypad, a touch panel sensor, a microphone, and the like. Similarly, in some embodiments, the processor 202 can be coupled to a transceiver 214 that interfaces with an antenna 216. The transceiver 214 can be configured to both transmit and receive cellular network signals, wireless data signals, or other types of signals via the antenna 216, depending on the nature of the mobile device 200. Further, in some configurations, a global positioning system (GPS) receiver 218 can also make use of the antenna 216 to receive GPS signals.

### Example User Interfaces of an Data Analysis System

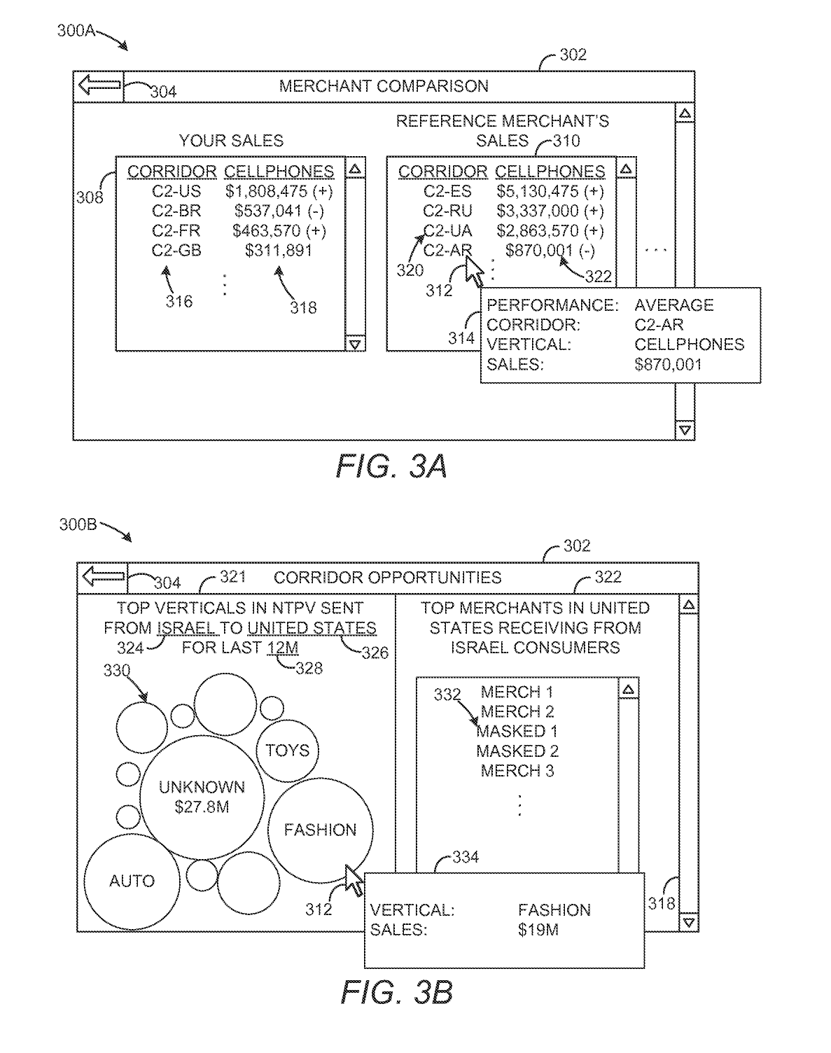

FIGS. 3A and 3B are interface diagrams illustrating example user interfaces 300A, 300B of a web resource with multiple display elements delivered to a user device by a data analysis system, according to an example embodiment. As used herein, a web resource can correspond to data and/or code delivered to the user device over a network to render a webpage or to be processed and rendered by another software application executing on the user device. The user device can correspond to the client machine 110 of FIG. 1 in an example embodiment. Data including the web resources can be provided by the networked system 102.

As will be described in detail below, the cross-border evaluation data can include a number of types of data for facilitating different comparisons of cross-border transaction activities within an online marketplace. In an example embodiment, the cross-border evaluation data can include data for facilitating an evaluation of cross-border transaction within a particular market vertical of the seller user and one or more reference users. In an example, for each displayed user, the data can include a number of country corridors paired with respective sales values. The data can be organized, for instance, in a table or array data structure. An example of a user interface 300A for displaying the data will be described in greater detail in connection with FIG. 3A.

As used herein, a sales value can correspond to any suitable metric indicative of an amount of sales activity. Example types of sales values can include, but are not limited to, gross sales (e.g., total payment value), net sales (gross sales less returns, charge backs, fees, etc.), number of transactions, number of items sold, number of customers, and the like.

In another example embodiment, the cross-border evaluation data can include data for facilitating an evaluation of cross-border performance within a particular country corridor of the seller user and a number of reference users. In an example, for each displayed user, the data can include a number of vertical markets paired with respective sales values. The data can be organized, for instance, in a table or array data structure. An example of a user interface 300B for displaying the data will be described in greater detail in connection with FIG. 3B.

Turning to the example embodiment of FIG. 3A, the user interface 300A includes a frame 302 and a control element 304 for navigating to another display of the user interface 300A. As shown, the user interface 300A displays cross-border evaluation data for facilitating an evaluation of a seller user's cross-border performance within a particular item category (e.g., the vertical market “CELLPHONES”). To this end, the frame 302 of the user interface 300A includes a sub-frame 308 to display the cross-border evaluation data of the seller user and a sub-frame 310 for displaying cross-border evaluation data of a number of reference users (“reference merchant”). Furthermore, the user interface 300A includes a cursor 312 for facilitating user interaction with the user interface 300A. A window 314 can be display based on user input received from the seller user, as will be described below.

The sub-frame 308 includes a column 316 to display a number of country corridor identifiers and a column 318 to display sales values that are indicative of past sales by the seller user for each of the country corridor identifiers of the column 316. The data of the columns 316, 318 can be generated from user account data that is linked to the seller user.

In the example embodiment shown in FIG. 3A, the country corridor identifiers of the column 316 include an origin identifier combined with a destination identifier. The identifiers can correspond to codes in accordance with a standard, such as the International Organization for Standardization (ISO) under ISO-3166-1. For example, the identifier “C2” corresponds to China for CHINA UNIONPAY (CUP), bank card, and cross-border transactions, whereas an identifier “CN” corresponds to domestic Chinese bank transactions. The identifier “US” corresponds to the United States of America. The identifier “BR” corresponds to Brazil. The identifier “FR” corresponds to France. The identifier “GB” corresponds to the United Kingdom. The identifier “ES” corresponds to France. The identifier “RU” corresponds to the Russian Confederation. The identifier “UA” corresponds to Ukraine. The identifier “AR” corresponds to Argentina. It will be appreciated that additional countries can be linked to other country codes and, in some embodiments, other suitable identifier codes can be used to indicate a country or geographical region.

As such, the country corridor identifier “C2-US” is indicative of a country corridor identifier that corresponds to China as the origin country and the United States of America as the destination country. The total sales for the seller user in this country corridor corresponds to $1,808,475, as indicated within the column 318.

Furthermore, the column 318 can include a graphical indication for indicating whether the total sales value is greater or less than the average seller within the country corridor. For example, an indicator “(+)” denotes that the seller user has a greater than average total sales value for the country corridor. An indicator “(−)” denotes that the seller user has a lower than average total sales value for the country corridor. The absence of either “(+)” or “(−)” can denote that the seller user has a sales value that is within a threshold of the average total sales value for the country corridor. It will be appreciated that any suitable type of graphical indication, such as a color code (e.g., green/red), graphics (e.g., up/down arrows), and/or the like, can be used to denote the relative performance of the seller user in comparison with an average or a particular reference user.

The sub-frame 310 can include columns 320, 322 to display the cross-border evaluation data of a number of reference users in a format that is similar to the columns 316, 318 as described above in connection with the sub-frame 308. The country corridors of the column 320 can each have an origin country matching the origin country of the seller user.

The reference user can be selected from a plurality of users of the online marketplace based on the amount of sales performed by the reference user. For example, the reference users can be selected based on having the highest total sales or other sales attribute originating from the origin country (e.g., China). In an alternative example embodiment, the reference users can be selected based on having total sales or other sales attribute comparable (within a threshold value) of the seller user. Other sales attributes can include net sales volume, gross sales volume, number of transactions, number of items sold, number of customers, number of countries sold to, and/or the like. And yet another example embodiment, the reference users can be selected based on a user selection.

An example embodiment, the reference user can correspond to a particular user whose identity is to be either masked or unmasked. In alternative example embodiment, the reference user can correspond to a “representative” user that can be generated by averaging and/or aggregating total sales from a number of users.

The window 314 can correspond to a pop up window that appears in response to a user selecting a row from the columns 316, 318, 320, 322. The window 314 can provide additional information for the country corridor of the selected row. For example, the window 314 can provide description of the relative performance within the country corridor, the country corridor identifier, the vertical market identifier, total sales, and/or the like.

Turning to the example embodiment of FIG. 3B, the user interface 300B displays cross-border evaluation data for facilitating an evaluation of the seller user's cross-border activities within a particular country corridor. The user interface 300B includes the frame 302, the control element 304, and the cursor 312 as described in connection with FIG. 3A. The user interface 300B includes a sub-frame 321 to display data related to sales values of a number of vertical markets. Additionally or alternatively, the user interface 300B includes a sub-frame 322 to display a list of a number of sellers who transact with customers within the particular country corridor.

In the illustrated example embodiment of FIG. 3B, the sub-frame 321 includes elements 324, 326, 328. The element 324 can indicate the origin country. The element 326 can indicate the destination country. As such, the elements 324, 326 can determine the country corridor. The element 328 can indicate the time period covered by the cross-border evaluation data. Each of the elements 324, 326, 328 can correspond to display elements or control elements. For example, the elements 324, 326, 328 can correspond to hypertext that is selectable by the user to change the value of the respective elements.

The sub-frame 321 also includes a graphical representation 330 of the relative sizes of the sales values linked to the seller user with respect to the vertical markets within the country corridor specified by the elements 324, 326. For example, the graphical representation 330 can correspond to a bubble graph including a number of bubbles (e.g., “UNKNOWN,” “AUTO,” “FASHION,” “TOYS,” etc.) having sizes that are indicative of the total sales values of the respective vertical markets. The sales values can be determined based on sales history data of the user account data linked to the seller user.

Moreover, the seller user can select a bubble of the graphical representation 330 to control the display of the sub-frame 321. For example, the seller user can use the cursor 312 to delete or move the selected bubble. Additionally or alternatively, the cursor 312 can be used to select a bubble of the graphical representation 330 to instantiate a window 336. For example, the window 336 can be a pop-up window that provides additional information related to the selected bubble. The window 336 can include a description of the vertical market and the total sales value of the vertical market, among other information related to the selected vertical market.

The sub-frame 322 can include a sub-frame 332 that in turn includes a list 334 of users of the online marketplace who sell items within the particular country corridor. It will be appreciated that in some example embodiments that the names of the users can be listed in a way as to protect the identities of the users. For example, the names listed in the list 334 can be general descriptive names and/or masked out in a way that state the name of the user or the user's business name.

### Example Data Analysis Systems

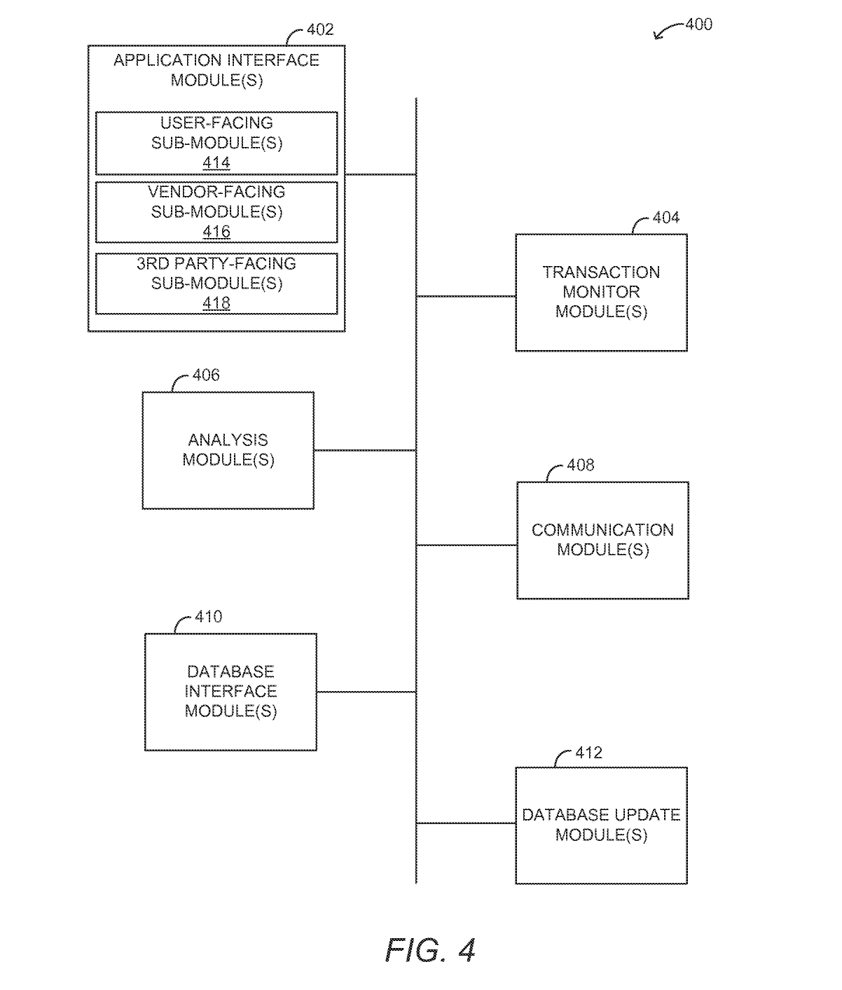

FIG. 4 is a block diagram illustrating an example embodiment of a data analysis system 400 including multiple modules forming at least a portion of the client-server system of FIG. 1. The modules 402-412 of the illustrated data analysis system 400 include an application interface module(s) 402, a transaction monitor module(s) 404, an analysis module(s) 406, a communication module(s) 408, a database interface module(s) 410, and a database update module(s) 412. The application interface module(s) 402 includes a user-facing sub-module(s) 414, an application-facing sub-module(s) 416, and a third party-facing sub-module(s) 418.

In some embodiments, the components of the data analysis system 400 can be included in the marketplace application 120 of FIG. 1. However, it will be appreciated that in alternative embodiments, one or more components of the data analysis system 400 described below can be included, additionally or alternatively, in other devices, such as one or more of the payment application 122, the servers 114, 116, 118, 130, the network 104, and/or the client machines 110, 112 of FIG. 1.

The modules 402-412 of the data analysis system 400 can be hosted on dedicated or shared server machines (not shown) that are communicatively coupled to enable communications between server machines. Each of the modules 402-412 are communicatively coupled (e.g., via appropriate interfaces) to each other and to various data sources, so as to allow information to be passed between the modules 402-412 of the data analysis system 400 or so as to allow the modules 402-412 to share and access common data. The various modules of the data analysis system 400 can furthermore access one or more databases 126 via the database server(s) 124.

The data analysis system 400 can facilitate generating cross-border evaluation data for evaluating transaction data of an online marketplace. In a particular example, the data analysis system 400 can facilitate automatically collecting sales data of the online marketplace. Furthermore, the data analysis system 400 can determine a triggering event for providing to the user the cross-border evaluation data automatically based on aggregated sales data collected. To this end, the data analysis system 400 illustrated in FIG. 4 includes the transaction monitor module(s) 404, the analysis module(s) 406, the communication module(s) 408, the database interface module(s) 410, and the database update module(s) 412.

The application interface module(s) 402 can be a hardware-implemented module which can be configured to communicate data with client and/or server devices. From the perspective of the data analysis system 400, client devices can include user devices, such as the client machine 110 of FIG. 1, and/or vendor devices, such as the application server(s) 118 of FIG. 1. Server devices can include servers executing applications providing one or more services to facilitate the operation of the data analysis system 400.

The user-facing sub-module(s) 414 can interface with user devices, such as the client machine 110 of FIG. 1. The vendor-facing sub-module(s) 416 can interface with client devices linked to registered vendors. The third-party-facing sub-module(s) 418 can interface with a number of third-party servers. In example embodiments, the data analysis system 400 can interface with third-party applications 128 that provide web-based services, such as, but not limited to, search services, data storage, data management, data mining, web-activity monitoring and analytics, and like services. The data analysis system 400 can receive such services by interacting with, for example, the third party application 128.

In an example embodiment, the user-facing sub-module(s) 414 can provide user interface data for rendering on client devices. For example, the data analysis system 400 can provide data for display of the cross-border evaluation data within a webpage or software application. Example graphical displays were described above in connection with the user interfaces 300A, 300B of FIGS. 3A and 3B.

The transaction monitor module(s) 404 can be a hardware-implemented module which can facilitate determining whether a transaction event satisfies a user notification rule. For example, the transaction monitor module(s) 404 can access transaction events received by the application interface module(s) 402. The transaction monitor module(s) 404 can compare the transaction events with a number of user notification rules to determine whether the transaction event satisfies a user notification rule. In response to the transaction monitor module(s) 404 determining that a received transaction event satisfies a notification rule, the data analysis system 400 can provide cross-border evaluation data to a user device linked to the transaction event.

Examples of transaction events can include a number of types of events within the online marketplace. For instance, a transaction event can correspond to a sales event between a buyer user and the seller user within the online marketplace. As such, sales data can be linked to the item of the transaction and linked to a user account of the seller of the item. Furthermore, the sales data can be indicative of an origin country and a destination country. Where the origin and the destination countries are different, the sales data represents a cross-border transaction.

Example transaction events can additionally or alternatively correspond to a user input event. One example type of user input, for instance, can correspond to data that is indicative of a request by a seller user to allow sales of the seller user's items to a selected cross-border country. Another example type of user input can correspond to a request message initiated by the seller user to request that cross-border evaluation data be sent to the seller user. Yet another example type of user input, for instance, can correspond to a change to user account data. For example, certain changes to the user account of the seller user can indicate that the seller user is preparing for cross-border transactions. Such changes can include, for example, an upgrade to a business or premium account status, adding an additional holding account in another currency, permitting the online marketplace to accept payment from another country automatically without user confirmation, and/or the like.

A notification rule can correspond to a number of rules, either separately or in combination, that can trigger the data analysis system 400 to provide to a user device cross-border evaluation data. Rules can be based on a number of transactions events (e.g., sales) having a characteristic (e.g., a cross-border sale), a number of sold items of transactions events (total number of items sold in cross-border sales), a number of cross-border destination countries to which the seller user has sold items, and/or a time element (e.g., a specified time after a cross-border transaction event).

As such, example notification rules can be satisfied in response to the transaction monitor module(s) 404 determining that a seller user has had a number of cross-border transactions that exceeds a threshold number, the seller user has sold a number of items or to a number of destination countries that exceeds a threshold number, the time since a cross-border transaction by the seller user exceeds a threshold period of time, and/or the time since cross-border evaluation data was last provided to the seller exceeds a threshold period of time. For illustration purposes only, the data analysis system 400 can generate and provide cross-border evaluation data in response to the seller user selling 50 or more items in cross-border transactions, selling items to users in three or more different countries, and/or after 6 months after the first cross-border transaction, in an example embodiment. As such, the notification rule can facilitate providing to users the cross-border evaluation data automatically without a direct user request.

In an example embodiment, a seller user can provide user input data to manage the notification rules linked to the user. Notifications rules can be added, deleted, and/or edited. For example, the user input data can be indicative of an attribute of a transaction event and a threshold for the number of transaction events matching the attribute to satisfy the user-defined notification rule. As such, the data analysis system 400 can facilitate user adjustable system for automatically generating and/or providing cross-border evaluation data.

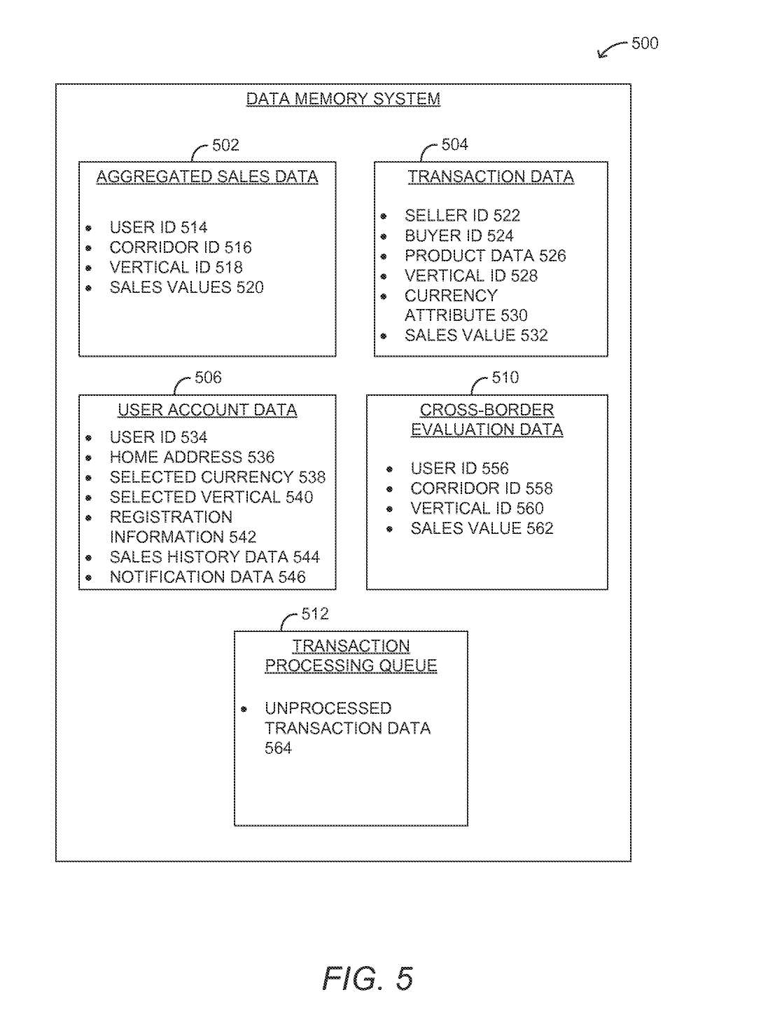

The transaction monitor module(s) 404 can also be configured to aggregate sales data based on transactions received within the online marketplace. For example, the transaction monitor module(s) 404 can store a number of records that are each representative of a sales transaction. An example embodiment of aggregated sales data will be described in greater detail later in connection with FIG. 5. The transaction monitor module(s) 404 can generate a record in response to a determination that a sales transaction is a cross-border transaction in an example embodiment (e.g., based on a determination that the origin country and destination country are different). In an alternative example embodiment, the transaction monitor module(s) 404 can generate a record of each sales transaction processed within the online marketplace.

The analysis module(s) 406 can be a hardware-implemented module which can facilitate generating cross-border evaluation data in response to a determination that a transaction event satisfies a user notification rule. For example, the transaction monitor module(s) 404 can provide to the analysis module(s) 406 a request message to generate cross-border evaluation data for an identified seller user. The analysis module(s) 406 can generate the cross-border evaluation data based at least on a selected portion of the aggregated sales data. For instance, the selected portion can be indicative of aggregated sales values linked to the origin country of the user (e.g., as indicated by the user account linked to the user). The selected portion can be further selected based on additional factors, such as based on country corridor, market vertical categories, and/or the like.

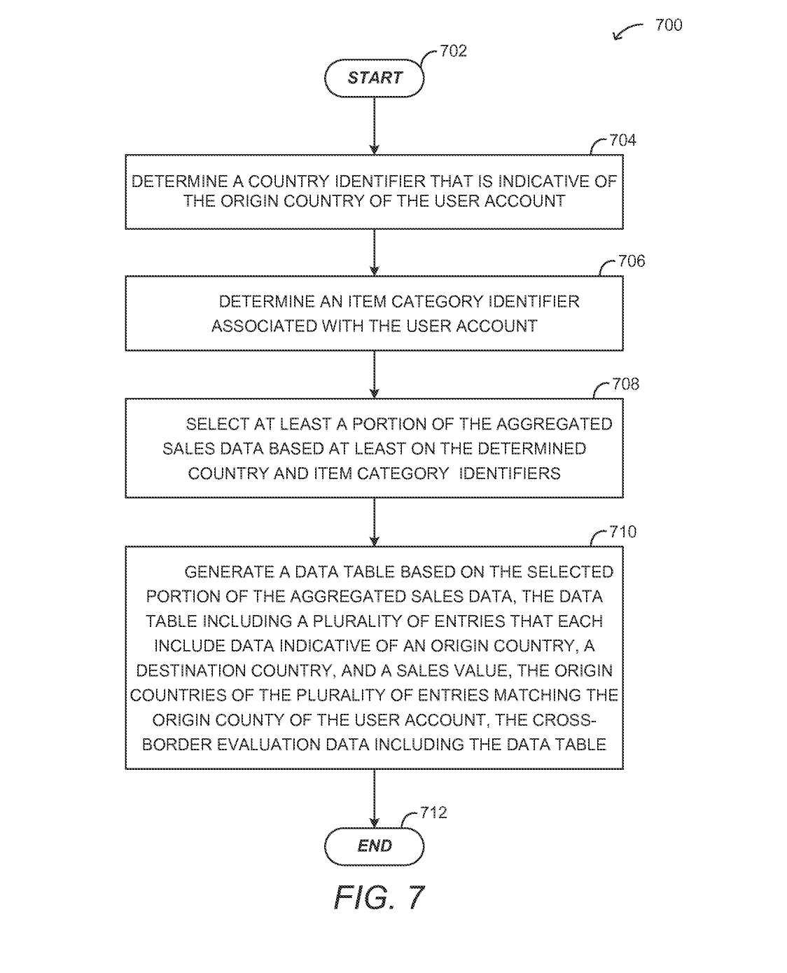

As described above in connection with FIGS. 3A and 3B, the selected portion of the aggregated sales data can be used to generate cross-border evaluation data that provides a number of indications. In example embodiments, the cross-border evaluation data can be indicative of the sales data of a number of reference users in the origin country of the seller user (e.g., such as shown by the user interface 300A). Furthermore, the sales data for the seller user and the reference users can be subdivided by country corridor. An example method of generating cross-border evaluation data similar to this type will be described in greater detail in connection with FIG. 7.

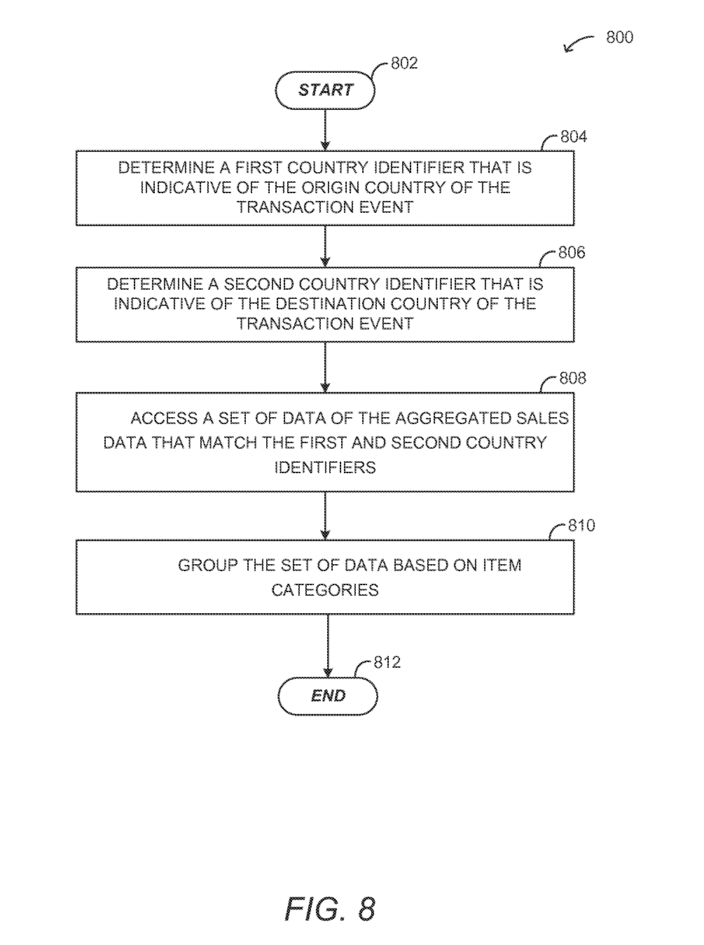

In another example embodiment, the cross-border evaluation data can be indicative of the sales values linked to a number of vertical markets of a country corridor having an origin country matching the origin country of the seller user. An example method of generating cross-border evaluation data similar to this type will be described in greater detail in connection with FIG. 8.

The communication module(s) 408 can be a hardware-implemented module which can facilitate data communication with components that are external to the data analysis system 400. For example, the communication module(s) 408 can interface with a network (e.g., the network 104 of FIG. 1) for transmitting and receiving network data packets in accordance with a network protocol. In operation, the communication module(s) 408 can receive data representative of the transaction events and can provide cross-border evaluation data for display on a user device linked to the first user account.

The database interface module(s) 410 can be a hardware-implemented module which can facilitate accessing data for the data analysis system 400. In an example embodiment, the database interface module(s) 410 can interface with the database 126 of FIG. 1. The database interface module(s) 410, in operation, can access the aggregated sales data, among other cross-border transaction data, as will be described in greater detail later in connection with FIG. 5.

The database update module(s) 412 can be a hardware-implemented module which can facilitate to initiate an update process of the aggregated sales data. The update can be based on received transaction messages received from user devices of the online marketplace that have not been combined with the aggregated sales data.

For instance, the transaction monitor module(s) 404 can store received transaction messages in a transaction queue. The database update module(s) 412 can initiate an update process in response to a number of determinations. The update process corresponds to updating the aggregated sales data by processing the transaction messages stored in the transaction queue. In an example, the database update module(s) 412 can initiate the update process response a determination that a number of the transaction messages stored in the transaction queue is greater than a threshold. Additionally or alternatively, the database update module(s) 412 can initiate the update process in response to a determination that a duration of time elapsed.

### Example Data Structures

FIG. 5 is a block diagram illustrating an example data memory system 500 including a number of data structures of the data analysis system 400, in accordance with an example embodiment. The data memory system 500 includes aggregated sales data 502, transaction data 504, user account data 506, cross-border evaluation data 510, and a transaction processing queue 512. It will be appreciated that the data of the data memory system 500 can be stored together or separately in a number of data storage devices by one or more components of the client-server system 100. In an example embodiment, the data memory system 500 can be embodied by the database 126 of FIG. 1.

The aggregated sales data 502 can be used by the analysis module(s) 406 to generate cross-border evaluation data. The aggregated sales data 502 includes one or more records (or “entries”), each including a user ID data field 514, a country corridor identifier 516, a vertical identifier 518, and a sales value 520.

The user ID data field 514 can be indicative of a reference user. In example embodiments, the reference user can correspond to selected user account data of merchants of the online marketplace. Additionally or alternatively, the reference user can correspond to an average of one or more seller users of the online marketplace. As described above, the user ID 514 can correspond to secure data that hides the identity of the merchant. As such, the data analysis system 400 can facilitate protecting private information of the merchants of the online marketplace.

The corridor ID 516 can be indicative of a country corridor associated with the corresponding record. The vertical ID 518 can be indicative of a vertical market associated with the corresponding record. Examples of vertical markets can include categories of goods and services substantially specific to an industry, trade, profession, or other group of customers with specialized needs. Example of vertical market can include electronics, home goods, cosmetics, jewelry, toys, gaming, website-services, fashion, automobile parts, software, consulting, travel, sports equipment, health, real estate, collectibles, art, and the like categories of items and services of online marketplaces.

The sales values 520 can be indicative of a monetary amount associated with the corresponding record. For instance, the sales value 520 can correspond to the total amount of sales linked to the user associated with user id 514 for the country corridor associated with the corridor ID 516 and the vertical market associate with the vertical ID 518. The total amount of sales can be calculated from the beginning of the sales history of the user associated with the user ID 514. It will be appreciated, however, that the total amount of sales can be calculated for a fixed window of time (e.g., over the past six months) in alternative example embodiments.

The transaction data 504 includes a seller ID 522, a buyer ID 524, a product data 526, a vertical ID 528, the currency attribute 530, and a sales value 532. The transaction data 504 can correspond to data representative of a transaction event, such as a sales transaction, within the online marketplace. It will be appreciated that the transaction data 504 can include additional or fewer elements in alternative embodiments. Additional element can include the associated tax or fees (e.g., customs) and the status of the payment (e.g., completed, pending, failed, etc.).

As such, the seller ID 522 can be indicative of the seller user. The buyer ID 524 can be indicative of the buyer user. The product data 526 can correspond to data that is indicative of product information of the corresponding sold item linked to the transaction event. The vertical ID 528 can be indicative of a vertical market link to the transaction event. The currency attribute 530 can be indicative of a currency type (e.g., U.S. dollar, yen, euro, pound sterling, yuan, renminbi, rand, digital currency (e.g., BITCOIN™, or the like currencies). The sales value 532 can correspond to a value of the sale with respect to the currency indicated by the currency attribute 530.

The user account data 506 includes a user ID 534, location data 536, a selected currency 538, a selected vertical 540, registration information 542, sales history data 544, and notification data 546. The user account data 506 can store information linked to a seller user for facilitating the seller user's activity within the online marketplace. The user ID 534 can correspond to data that is indicative of the seller user linked to the user account data 506. The location data 536 can serve to indicate the location of the seller user. The location data 536 can correspond to the location (e.g., origin country) assigned to the account and need not correspond to the current location of the seller user. The selected currency 538 can serve to indicate the seller user's currency type. The selected vertical 540 can include data that is indicative of a vertical market category selected by the seller user. The registration information 542 may include authentication and authorization data linked to the seller user. The sales history data 544 can include data that is indicative of past sales and purchases of the seller user.

The notification data 546 can include data for facilitating the notification rules linked to the user. For example, the notification data 546 can include data that is representative of a number of attributes, thresholds, and counters. A pair of attribute and threshold can be used to define a notification rule. For example, an attribute of “CBT_ITEMS” and a threshold of “50” can correspond to a notification rule that triggers the data analysis system 400 to provide cross-border evaluation data to the seller user in response to the seller user selling 50 items in cross-border transactions. The counter can serve is a run-time counter of the current number of items satisfying the attribute (e.g., the notification rule is satisfied when the counter is greater than a threshold). As such, in operation, the data analysis system 400 can compare the counter and the threshold to determine whether the notification rule is satisfied.

The cross-border evaluation data 510 includes a number of records, each including a user ID 556, a core door ID 558, a vertical ID 560, and a sales value 562. The user ID 556, the corridor ID 558, the vertical data 560, and the sales values 562 can serve a similar role as the corresponding components of the aggregated sales data 502. The cross-border evaluation data 510 can serve to store cross-border evaluation data to be provided to the seller user. The cross-border evaluation data 510 can include sales data for the seller user and for one or more reference users.

The transaction processing queue 512 includes unprocessed transaction data 564. In an example embodiment, the unprocessed transaction data 564 can include a number of records corresponding to data having a structure similar to the transaction data 504. In operation, the transaction monitor module's 404 can store transaction data in the transaction processing queue 512 for later processing by the database update module(s) 412. The processing can include updating the aggregated sales data 502 based on the unprocessed transaction data 564 of the transaction processing queue 512. The data analysis system 400 can process the transaction processing queue 512 based on a schedule (e.g., daily, weekly, etc.) and/or based on an event (e.g., the transaction processing queue storing a number of records greater than a threshold).

### Example Methods of Data Analysis Systems

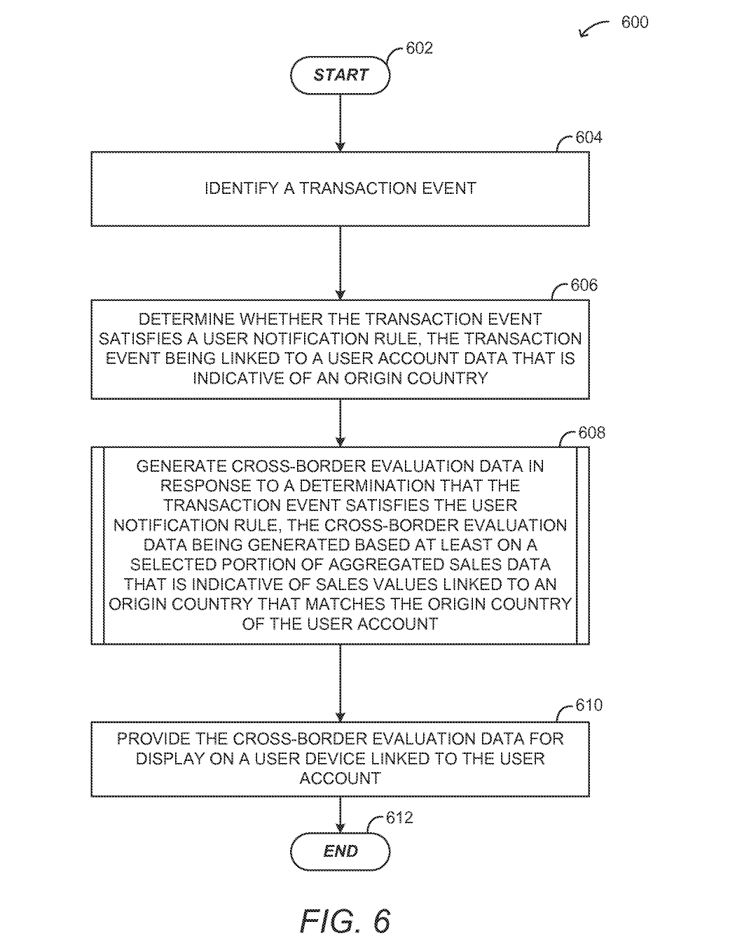

FIG. 6 is a flowchart illustrating an example method 600 of providing cross-border evaluation data based on aggregated sales data of an online marketplace, in accordance with an example embodiment. In this example, the method 600 can include operations such as identifying a transaction event (block 604), determining whether the transaction event satisfies a user notification rule (block 606), generating cross-border evaluation data (block 608), and providing the cross-border evaluation data (block 610). The example method 600 will be described below, by way of explanation, as being performed by certain modules. It will be appreciated, however, that the operations of the example method 600 can be performed in any suitable order by any number of the modules shown in FIG. 4.

The method 600 starts at block 602 and proceeds to block 604 for identifying a transaction event. For example, the transaction monitor module(s) 404 can receive data within the online marketplace and can determine whether the received data corresponds to a transaction event, such as, but not limited to, the transaction data 504 of FIG. 5 of a sales event. Accordingly, the transaction event can be linked to user account data associated with the seller user (e.g., via the seller ID 522) and, additionally or alternatively, user account data associated with the buyer user (e.g., via the buyer ID 524).

In particular, the transaction monitor module(s) 404 can monitor for cross-border type sales transactions. For example, a sale can be determined as being a cross-border sale based on a comparison of the location data of the seller and user. The locations of the users can be determined based on the user account data (e.g., user account data 506) of the users. The user account data can be accessed based on the buyer and seller IDs 522, 524 of the transaction data 504. A determination that the location data of the buy and seller are different, then the sale can be identified as a cross-border transaction. Cross-border sales data can be stored in the transaction processing queue 512 for later processing.

At block 608, the analysis module(s) 406 generates cross-border evaluation data in response to a determination by the transaction monitor module(s) 404 that the transaction event satisfies the user notification rule. The cross-border evaluation data (e.g., the cross-border evaluation data 510 of FIG. 5) can be generated based at least on a selected portion of the aggregated sales data 502 of FIG. 5. As stated, the selected portion of the aggregated sales data 502 can be selected based on being linked to an origin country that matches the origin country of the user account. Two example methods of generating different cross-border evaluation data will be described in greater detail later in connection with FIGS. 7 and 8.

In an example embodiment, the analysis module(s) 406 can convert the sales values of the cross-border evaluation data 510 to the currency of the seller user. For example, the analysis module(s) 406 can determine the currency of the seller user by accessing the selected currency 538 of the user account data 506. Current conversion rates can be used.

At block 610, the communication interface module(s) 408 provides the generated cross-border evaluation data for display on a user device link to the user account data 506.

Additionally or alternatively, data of a message can be provided to the seller user. The message can provide to the seller user a notice that the first foreign payment of this type was received, a list of reference users in the seller user's vertical market category who sell to same region based on the currency and statistics about those sales, a recommendation of other countries to market the product based on the currency, a suggestion of solutions for cross-border trade (e.g., shipping, insurance, custom, etc.), trend data of the exchange rate between the new currency and seller user's currency, and the like information related to cross-border transactions.

At block 612, the method 600 can end.

FIG. 7 is a flowchart illustrating an example method 700 of generating the cross-border evaluation data of FIG. 6, in accordance with an example embodiment. For instance, the example method 700 can correspond to generating the cross-border evaluation data for the user interface 300A of FIG. 3A. As stated, the user interface 300A provides to the seller user cross-border evaluation data that is indicative of sales performance of one or more reference users in comparison to the seller user. It will be appreciated that the example method 700 can be performed at block 608 of FIG. 6.

In this example, the method 700 can include operations such as determining a country identifier (block 704), determining an item category identifier (block 706), selecting a portion of the aggregated sales data (block 708), and generating a data table based on the selected portion of the aggregated sales data (block 710). The example method 700 will be described below, by way of explanation, as being performed by certain modules. It will be appreciated, however, that the operations of the example method 700 can be performed in any suitable order by any number of the modules shown in FIG. 4.

In an example embodiment, the analysis module(s) 406 starts the method 700 at block 702 and proceeds to block 704 for determining a country identifier that is indicative of the origin country of the user account of the seller user. For instance, in an example embodiment, the analysis module(s) 406 can access the user account data 506 linked to the seller user to determine an identifier of the origin country as indicated by the location data 536.

At block 706, the analysis module(s) 406 determines an item category identifier associated with the user account of the seller user. The item category identifier can be indicative of one of a number of vertical markets. Furthermore, the item category identifier can be associated with the user account and a number of ways. For instance, the analysis module(s) 406 can determine the item category identifier based on the selected vertical identifier 540 of the user account data 506. Additionally or alternatively, the item category identifier can be determined based on the vertical ID 528 of the transaction data 504 that is linked to the user account data 506.

At block 708, the analysis module(s) 406 selects at least a portion of the aggregated sales data 502. The selection can be based at least on the country and item category identifiers determined at block 706. For example, the analysis module(s) 406 can select a number of entries of the aggregated cells data 502 that have country corridor IDs 516 that correspond to country corridors having an origin country identified by the country identifier determined at block 706. Further, the analysis module(s) 406 can select a number of entries of the aggregated sales data 502 that additionally or alternatively have vertical data 518 that match the vertical market identified by the item category identifier that was determined at block 706. As a result, the selected portion of the aggregated sales data 502 comprises entries that correspond to transactions from the origin country of the seller user and within a vertical market of the seller user.

In an example embodiment, the selection of the portion of the aggregated sales data 502 can be constrained to select records of the aggregated sales data 502 that correspond to users having a number of attributes. For example, the analysis module(s) 406 can select records based on the records being linked to users having certain attributes that are similar to the seller user to provide a meaningful data for the seller user. Attributes can correspond to total sales, sales volume (gross or net sales), number of transactions, number of customers, number of countries sold to, and/or the like. The selected users of the aggregated sales data 502 can be combined into one or more groups to form the reference users to generate cross-border evaluation data of the reference users.

At block 710, the analysis module(s) 406 generates a data table based on the selected portion of the aggregated sales data 502. The data table can include a plurality of entries that each include data indicative of an origin country, destination country, and a sales value. For instance, in an example embodiment, the generated data table can correspond to the cross-border evaluation data 510 of FIG. 5. In response to generating the cross-border evaluation data, the method 700 can end at block 714.

In an example embodiment, the entries of the cross-border evaluation data 510 generated at block 710 can be grouped into two sets. The first set can correspond to the seller user's sales data, such as shown displayed in frame 308 of FIG. 3A, that can be generated based on the sales history data 544 of the user account data 506. In particular, the analysis module(s) 406 can select and use a portion of the sales history data 544 matching the item category identifier (e.g., the vertical market) to generate the first set of data. Moreover, the sales values can be grouped by country corridors, as shown in FIG. 3A.

The second set of data can correspond to a reference user's data, such as shown displayed in frame 310 of FIG. 3A, that is generated from the aggregated sales data 502 as described above in connection with blocks 704-708. The reference user, as stated, can correspond to a particular second seller user within the online marketplace. In an example embodiment, the identity of the reference user can be masked user such that the user interface 300A does not display data that reveals the identity of the reference user. Additionally or alternatively, the reference user can correspond to averaged sales values from a number of second seller users.

Furthermore, in an example embodiment, the cross-border evaluation data can include data for more than one reference user. The number of reference users can based on the available display size of the user interface, a default value, user input data indicative of a user-selected number, and/or the like. Selection of the reference users can be based on the reference users being linked an origin country matching the origin country of the seller user. Other attribute, as discussed above, can be used to select user to form the reference users.

FIG. 8 is a flowchart illustrating another example method 800 of generating the cross-border evaluation data in the method 600 of FIG. 6, in accordance with an example embodiment. For instance, the example method 800 can correspond to generating the cross-border evaluation data 510 of FIG. 5 for display within the user interface 300B of FIG. 3B. As stated, the user interface 300B provides to the seller user cross-border evaluation data 510 that is indicative of sales performance within a number of vertical markets of a particular country corridor. It will be appreciated that the example method 800 can be performed at block 608 of FIG. 6.

In this example, the method 800 can include operations such as determining first and second country identifiers (blocks 804 and 806), accessing a first set of data of the aggregated sales data (block 808), and grouping the first set of data based on item categories (block 810). The example method 800 will be described below, by way of explanation, as being performed by certain modules. It will be appreciated, however, that the operations of the example method 800 can be performed in any suitable order by any number of the modules shown in FIG. 4.

In an example embodiment, the analysis module(s) 406 starts at block 802 and proceeds to block 804 for determining a first country identifier that is indicative of the origin country of the transaction event. For example, the analysis module(s) 406 can determine the first country identifier based on data included by the transaction data 504 and/or by the user account data 506. One example process of determining the origin country was described above in connection with FIG. 7.

At block 806, the analysis module(s) 406 determines a second country identifier that is indicative of the destination country of the transaction event. The analysis module(s) 406 can determine the second country identifier based on data included by the transaction data 504 and/or by the user account data 506. For instance, the analysis module(s) 406 can use the buyer ID 524 of the transaction data 504 to access a second user account, which can have a data structure similar to the data structure of user account data 506. As such, the second user account can include location data usable for determining the destination country and thus the second country identifier. It will be appreciated that, in alternative example embodiments, destination country data can be included in the transaction data 504, which can be used by the analysis module(s) 406 to determine the second country identifier.

At block 808, the analysis module(s) 406 accesses a first set of data of the aggregated sales data 502. The first set of data can accessed by selecting entries of the aggregated sales data 502 that correspond to a particular country corridor to be displayed in the display element 330 of FIG. 3B. To this end, the pair of the first and second country identifiers can be used to determine the country corridor of the transaction event. As such, the analysis module(s) 406 can combine the first and second country identifiers to determine a country corridor identifier corresponding to the transaction event. The analysis module(s) 406 can compare the resulting country corridor identifier to the corridor ID 516 of a number of the aggregated sales data.

At block 810, the analysis module(s) 406 can group the first set of data based on item categories. For example, the item categories can correspond to vertical markets of items sold within the country corridor determined by the first and second country identifiers. The analysis module(s) 406 can group the first set of data such that the data can be displayed in way that the number of vertical markets linked to the country corridor are paired with the corresponding sales values, as shown in the display element 330.

Furthermore, for each item category, user IDs 556 and sales values 562 can be grouped or paired together such that masked and/or unmasked merchant names and corresponding sales values can be display together within the selected item category (e.g., as shown in data list 334). At block 808, the analysis module(s) 406 can end the method 800.

It will be appreciated that in an example embodiment the data analysis system 400 can perform both methods 700 and 800 at block 608. As such, the data analysis system 400 can facilitate providing data to display user interface 300A of FIG. 3A and user interface 300B of FIG. 3B.

Certain embodiments are described herein as including logic or a number of components, modules, or mechanisms. Modules can constitute either software modules (e.g., code embodied (1) on a non-transitory machine-readable medium or (2) in a transmission signal) or hardware-implemented modules. A hardware-implemented module is a tangible unit capable of performing certain operations and can be configured or arranged in a certain manner. In example embodiments, one or more computer systems (e.g., a standalone, client or server computer system) or one or more processors can be configured by software (e.g., an application or application portion) as a hardware-implemented module that operates to perform certain operations as described herein.

In various embodiments, a hardware-implemented module can be implemented mechanically or electronically. For example, a hardware-implemented module can comprise dedicated circuitry or logic that is permanently configured (e.g., as a special-purpose processor, such as a field programmable gate array (FPGA) or an application-specific integrated circuit (ASIC)) to perform certain operations. A hardware-implemented module can also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) can be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor can be configured as respective different hardware-implemented modules at different times. Software can accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules can be regarded as being communicatively coupled. Where multiple of such hardware-implemented modules exist contemporaneously, communications can be achieved through signal transmission (e.g., over appropriate circuits and buses) that connect the hardware-implemented modules. In embodiments in which multiple hardware-implemented modules are configured or instantiated at different times, communications between such hardware-implemented modules can be achieved, for example, through the storage and retrieval of information in memory structures to which the multiple hardware-implemented modules have access. For example, one hardware-implemented module can perform an operation, and store the output of that operation in a memory device to which it is communicatively coupled. A further hardware-implemented module can then, at a later time, access the memory device to retrieve and process the stored output. Hardware-implemented modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors can constitute processor-implemented modules that operate to perform one or more operations or functions. The modules referred to herein can, in some example embodiments, comprise processor-implemented modules.

Similarly, the methods described herein can be at least partially processor-implemented. For example, at least some of the operations of a method can be performed by one or more processors or processor-implemented modules. The performance of certain of the operations can be distributed among the one or more processors, not only residing within a single machine, but deployed across a number of machines. In some example embodiments, the processor or processors can be located in a single location (e.g., within a home environment, an office environment or as a server farm), while in other embodiments the processors can be distributed across a number of locations.

The one or more processors can also operate to support performance of the relevant operations in a “cloud computing” environment or as a “software as a service” (SaaS). For example, at least some of the operations can be performed by a group of computers (as examples of machines including processors), these operations being accessible via a network 104 (e.g., the Internet) and via one or more appropriate interfaces (e.g., application program interfaces (APIs).)

Example embodiments can be implemented in digital electronic circuitry, or in computer hardware, firmware, software, or in combinations of them. Example embodiments can be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network 104.

In example embodiments, operations can be performed by one or more programmable processors executing a computer program to perform functions by operating on input data and generating output. Method operations can also be performed by, and apparatus of example embodiments can be implemented as, special purpose logic circuitry, e.g., a field programmable gate array (FPGA) or an application-specific integrated circuit (ASIC).

The computing system can include clients and servers. A client and server are generally remote from each other and typically interact through a communication network 104. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware can be a design choice. Below are set out hardware (e.g., machine) and software architectures that can be deployed, in various example embodiments.

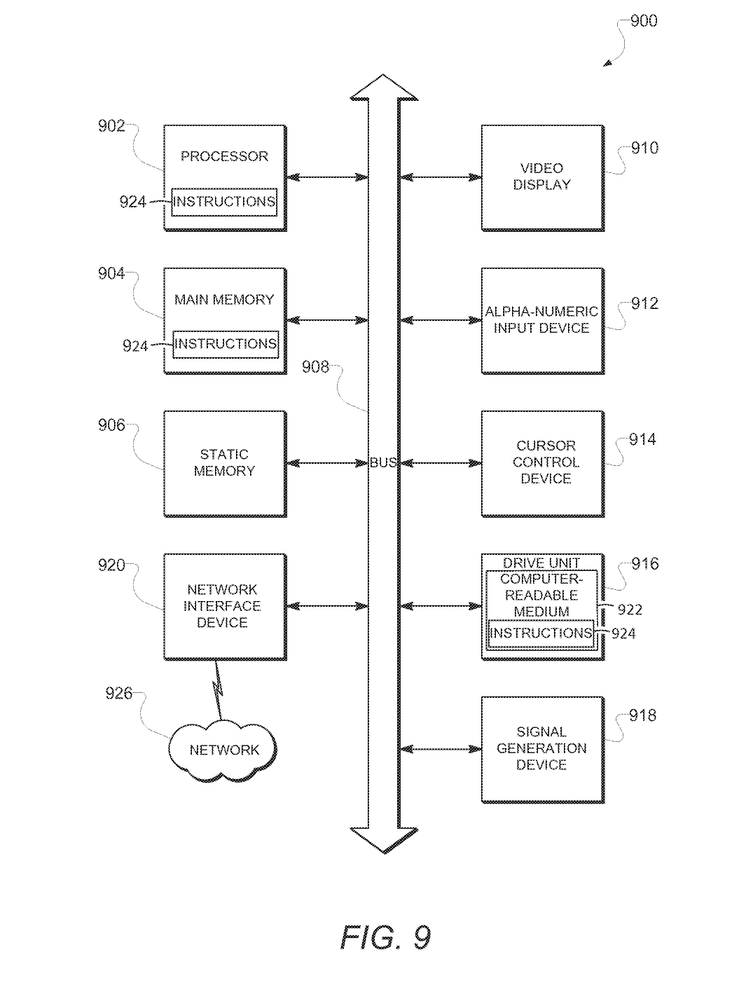

FIG. 9 is a block diagram of a machine in the example form of a computer system 900 within which instructions 924 can be executed for causing the machine to perform any one or more of the methodologies discussed herein. In alternative embodiments, the machine operates as a standalone device or can be connected (e.g., networked) to other machines. In a networked deployment, the machine can operate in the capacity of a server or a client machine 110 in server-client network environment, or as a peer machine in a peer-to-peer (or distributed) network environment. The machine can be a personal computer (PC), a tablet PC, a set-top box (STB), a personal digital assistant (PDA), a cellular telephone, a web appliance, a network router, switch or bridge, or any machine capable of executing instructions 924 (sequential or otherwise) that specify actions to be taken by that machine. Further, while only a single machine is illustrated, the term “machine” shall also be taken to include any collection of machines that individually or jointly execute a set (or multiple sets) of instructions 924 to perform any one or more of the methodologies discussed herein.

The example computer system 900 includes a processor 902 (e.g., a central processing unit (CPU), a graphics processing unit (GPU) or both), a main memory 904 and a static memory 906, which communicate with each other via a bus 908. The computer system 900 can further include a video display unit 910 (e.g., a liquid crystal display (LCD) or a cathode ray tube (CRT)). The computer system 900 also includes an alphanumeric input device 912 (e.g., a keyboard or a touch-sensitive display screen), a user interface (UI) navigation (or cursor control) device 914 (e.g., a mouse), a disk drive unit 916, a signal generation device 918 (e.g., a speaker) and a network interface device 920.

The disk drive unit 916 includes a computer-readable medium 922 on which is stored one or more sets of data structures and instructions 924 (e.g., software) embodying or utilized by any one or more of the methodologies or functions described herein. The instructions 924 can also reside, completely or at least partially, within the main memory 904 and/or within the processor 902 during execution thereof by the computer system 900, the main memory 904 and the processor 902 also constituting machine-readable media 922.

While the computer-readable medium 922 is shown, in an example embodiment, to be a single medium, the term “computer-readable medium” can include a single medium or multiple media (e.g., a centralized or distributed database, and/or associated caches and servers) that store the one or more instructions 924 or data structures. The term “computer-readable medium” shall also be taken to include any non-transitory, tangible medium that is capable of storing, encoding or carrying instructions 924 for execution by the machine and that cause the machine to perform any one or more of the methodologies of the present inventive subject matter, or that is capable of storing, encoding or carrying data structures utilized by or associated with such instructions 924. The term “computer-readable medium” shall accordingly be taken to include, but not be limited to, solid-state memories, and optical and magnetic media. Specific examples of computer-readable media 922 include non-volatile memory, including by way of example semiconductor memory devices, e.g., erasable programmable read-only memory (EPROM), electrically erasable programmable read-only memory (EEPROM), and flash memory devices; magnetic disks such as internal hard disks and removable disks; magneto-optical disks; and CD-ROM and DVD-ROM disks.

The instructions 924 can further be transmitted or received over a communications network 926 using a transmission medium. The instructions 924 can be transmitted using the network interface device 920 and any one of a number of well-known transfer protocols (e.g., hypertext transfer protocol (HTTP)). Examples of communication networks 926 include a local area network (LAN), a WAN, the Internet, mobile telephone networks, plain old telephone (POTS) networks, and wireless data networks (e.g., WiFi and WiMax networks). The term “transmission medium” shall be taken to include any intangible medium that is capable of storing, encoding or carrying instructions (e.g., instructions 924) for execution by the machine, and includes digital or analog communications signals or other intangible media to facilitate communication of such software.

Although the inventive subject matter has been described with reference to specific example embodiments, it will be evident that various modifications and changes can be made to these embodiments without departing from the broader spirit and scope of the inventive subject matter. Accordingly, the specification and drawings are to be regarded in an illustrative rather than a restrictive sense. The accompanying drawings that form a part hereof, show by way of illustration, and not of limitation, specific embodiments in which the subject matter can be practiced. The embodiments illustrated are described in sufficient detail to enable those skilled in the art to practice the teachings disclosed herein. Other embodiments can be utilized and derived therefrom, such that structural and logical substitutions and changes can be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter can be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose can be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed:

1. A system comprising:
a database interface module configured to access aggregated sales data of an online marketplace, the aggregated sales data being indicative of sales values linked to respective origin countries and respective destination countries;
a transaction monitor module configured to determine whether a transaction event satisfies a user notification rule, the transaction event being linked to a user account that is indicative of an origin country;
an analysis module, including one or more processors, configured to generate cross-border evaluation data in response to a determination that the transaction event satisfies the user notification rule, the cross-border evaluation data being generated based at least on a selected portion of the aggregated sales data that is indicative of sales values linked to an origin country that matches the origin country of the user account and linked to a destination country different than the origin country of the user account; and
a communication interface module configured to provide the cross-border evaluation data for display on a user device linked to the user account.

2. The system of claim 1, wherein the transaction event corresponds to a cross-border sales transaction, the user account being linked to the transaction event as a seller user of the cross-border sales transaction, the notification rule being satisfied based on the seller user being linked to at least a threshold number of cross-border sales transactions.

3. The system of claim 1, wherein the cross-border evaluation data includes a plurality of sales values linked to a reference user who is different from a user of the user account, the cross-border evaluation data further including data indicative a plurality of pairs of origin countries and destination countries linked to the plurality of sales values of the cross-border evaluation data.

4. The system of claim 3, wherein the plurality of sales values linked to the reference user corresponds to a plurality of averaged sales values linked to a plurality of users.

5. The system of claim 1, wherein the analysis module is configured to generate the cross-border evaluation data by being further configured to:
determine a country identifier that is indicative of the origin country of the user account;
determine an item category identifier associated with the user account;
select at least a portion of the aggregated sales data based at least on the determined origin country and the item category identifiers; and
generate a data table based on the selected portion of the aggregated sales data, the data table including a plurality of entries that each include data indicative of an origin country, a destination country, and a sales value, the origin countries of the plurality of entries matching the origin county of the user account, the cross-border evaluation data including the data table.

6. The system of claim 1, wherein the cross-border evaluation data is indicative of a plurality of item categories and corresponding sales values linked to the origin country of user account.

7. The system of claim 1, wherein the analysis module is configured to generate the cross-border evaluation data by being further configured to:
determine a country identifier that is indicative of the origin country of the user account;
determine a second country identifier that is indicative of a destination country linked the transaction event; and
based on the and second country identifiers, access a set of data of the aggregated sales data that match the country identifier data, the cross-border evaluation data including the aggregated sales data of the set of data grouped based on item categories.

8. The system of claim 1, further comprising a database update module configured to initiate an update process of the aggregated sales data based at least on received transaction messages received from user devices of the online marketplace.

9. The system of claim 8, wherein the database update module is configured to initiate an update process in response to a determination that a duration of time elapsed.

10. The system of claim 8, wherein the transaction monitor module is further configured to store received transaction messages in a transaction queue, wherein the update process corresponds to updating the aggregated sales data by processing the transaction messages stored in the transaction queue.

11. The system of claim 10, wherein the database update module is configured to initiate an update process in response to a determination that a number of the transaction messages stored in the transaction queue is greater than a threshold.

12. A computer-implemented method comprising:
accessing aggregated sales data of an online marketplace, the aggregated sales data being indicative of sales values linked to respective origin countries and respective destination countries;
determining whether a transaction event satisfies a user notification rule, the transaction event being linked to a user account that is indicative of an origin country;
generating, by one or more processors, cross-border evaluation data in response to a determination that the transaction event satisfies the user notification rule, the cross-border evaluation data being generated based at least on a selected portion of the aggregated sales data that is indicative of sales values linked to an origin country that matches the origin country of the user account and linked to a destination country different than the origin country of the user account; and
providing the cross-border evaluation data for display on a user device linked to the user account.

13. The computer-implemented method of claim 12, wherein the transaction event corresponds to a cross-border sales transaction, the user account is linked to the transaction event as a seller user of the cross-border sales transaction, and the notification rule is satisfied based on the seller user being linked to at least a threshold number of cross-border sales transactions.

14. The computer-implemented method of claim 12, wherein the cross-border evaluation data includes a plurality of sales values linked to a reference user who is different from a user of the user account, the cross-border evaluation data further including data indicative a plurality of pairs of origin countries and destination countries linked to the plurality of sales values of the cross-border evaluation data.

15. The computer-implemented method of claim 14, wherein the plurality of sales values linked to the reference user corresponds to a plurality of averaged sales values linked to a plurality of users.

16. The computer-implemented method of claim 12, wherein the generating of the cross-border evaluation data comprises:
determining a country identifier that is indicative of the origin country of the user account;
determining an item category identifier associated with the user account;
selecting at least a portion of the aggregated sales data based at least on the determined origin country and the item category identifiers; and
generating a data table based on the selected portion of the aggregated sales data, the data table including a plurality of entries that each include data indicative of an origin country, a destination country, and a sales value, the origin countries of the plurality of entries matching the origin county of the user account, the cross-border evaluation data including the data table.

17. The computer-implemented method of claim 12, wherein the cross-border evaluation data is indicative of a plurality of item categories and corresponding sales values linked to the origin country of user account.

18. A machine-readable storage medium embodying instructions that, when executed by a machine, cause the machine to perform operations comprising:
accessing aggregated sales data of an online marketplace, the aggregated sales data being indicative of sales values linked to respective origin countries and respective destination countries;
determining whether a transaction event satisfies a user notification rule, the transaction event being linked to a user account that is indicative of an origin country;
generating, by one or more processors, cross-border evaluation data in response to a determination that the transaction event satisfies the user notification rule, the cross-border evaluation data being generated based at least on a selected portion of the aggregated sales data that is indicative of sales values linked to an origin country that matches the origin country of the user account and linked to a destination country different than the origin country of the user account; and
providing the cross-border evaluation data for display on a user device linked to the user account.

19. The machine-readable storage medium of claim 18, wherein the transaction event corresponds to a cross-border sales transaction, the user account is linked to the transaction event as a seller user of the cross-border sales transaction, and the notification rule is satisfied based on the seller user being linked to at least a threshold number of cross-border sales transactions.

20. The machine-readable storage medium of claim 18, wherein the cross-border evaluation data includes a plurality of sales values linked to a reference user who is different from a user of the user account, the cross-border evaluation data further including data indicative a plurality of pairs of origin countries and destination countries linked to the plurality of sales values of the cross-border evaluation data.
